(19) United States
(12) Patent Application Publication
(10) Pub. No.: US 2025/0123107 A1
(43) Pub. Date: Apr. 17, 2025

(54) METHOD AND SYSTEM FOR PREDICTING A TRAJECTORY

(71) Applicant: HUAWEI TECHNOLOGIES CO., LTD., Shenzhen, Guangdong (CN)

(72) Inventors: Rezaul KARIM, North York (CA); Amir RASOULI, Etobicoke (CA); Soheil MOHAMAD ALIZADEH SHABESTARY, Toronto (CA)

(21) Appl. No.: 18/485,672

(22) Filed: Oct. 12, 2023

(51) Int. Cl. G01C 21/20

(52) U.S. Cl. CPC G01C 21/20

(57) ABSTRACT

The present invention relates to a prediction method of at least one trajectory Y of at least one agent a, the method may include acquiring at least one preliminary predicted trajectory Y, said preliminary predicted trajectory comprising a set of predicted points PT, aligning at least one point PTi of said set of predicted points PT with at least one point PTj of said set of predicted points PT using an analytically attention mask, and generating at least said predicted trajectory Y of said agent a, said predicted trajectory Y comprising at least said aligned point.

The present technology relates to the prediction of trajectories of mobile objects, and more specifically to methods and systems for predicting a trajectory of a mobile agent, such as an autonomous vehicle.

### BACKGROUND

Predicting future trajectories of road users is a fundamental prerequisite task for motion planning of autonomous driving systems. One of the key challenges in prediction is the inherent uncertainty of future behaviors stemming from unknowns, such as the intentions of the road users. Another key challenge in prediction is to generate temporally consistent trajectories that maintain the cause-effect relationship through time and are admissible meaning that they comply with the road structure. There are several prior arts in this domain specializing on pedestrians such as for example “Li, Lihuan and Pagnucco, Maurice and Song, Yang. 2022. “Graph-Based Spatial Transformer With Memory Replay for Multi-Future Pedestrian Trajectory Prediction.” CVPR.” and on vehicles such as for example “Kim, ByeoungDo and Park, Seong Hyeon and Lee, Seokhwan and Khoshimjonov, Elbek and Kum, Dongsuk and Kim, Junsoo and Kim, Jeong Soo and Choi, Jun Won. 2021. “LaPred: Lane-aware Prediction of Multi-modal Future Trajectories of Dynamic Agents.” CVPR.”.

In practice, some approaches impose such a consistency via observation reconstruction, or scene graph consistency computation all of which can be computationally prohibitive for time-sensitive tasks such as autonomous driving. Alternatively, some models rely on heuristics to impose agents' dynamical constraints, however, they require an accurate estimation of road users' dynamics parameters which are not readily known.

There is therefore a need for a new solution to solve these different technical problems.

### SUMMARY

The present invention has been developed for overcoming at least some drawbacks present in prior art solutions.

In this context, the present invention addresses at least one of the aforementioned challenges by introducing a temporal transductive alignment, optionally used in combination with dynamic goal queries.

The present invention uses a temporal transductive alignment (TTA) module, also called temporal module TM, that aligns preliminary predicted trajectory points across time to emulate behavior on top of non-autoregressively generated points. Besides being computationally efficient, the present invention operates on predicted trajectories, thus can be added to many existing prediction methods as a stand-alone module.

Optionally, the present invention benefits from an attention-based technique in which goal points are dynamically estimated using learned queries. In other words, the present invention provides a model that learns to attend to different contextual information to guide goal estimation without being bounded by any historical or hand-crafted elements.

The present invention relates to a prediction method of at least one trajectory Y of at least one agent a, said agent a being in a state s_{A} at a time t, where t∈T_{obs}, where T_{obs}={−t₀, . . . , 0} are observations time steps, said agent a being configured to be mobile according to at least one map Map, the method being executable by an electronic device, the electronic device being communicatively coupled to at least one database and/or at least one set of sensors, the method comprising:
Acquiring at least one preliminary predicted trajectory Y, said preliminary predicted trajectory comprising a set of predicted points PT, this set of predicted points PT defining said preliminary predicted trajectory Y, each point of said set of predicted points PT comprising at least one spatial coordinate and one temporal coordinate;
Aligning at least one point PTi of said set of predicted points PT with at least one point PTj of said set of predicted points PT using an analytically attention mask, said step of aligning comprising at least:
   Selecting at least said point PTj taken among the set of predicted points PT using said analytically attention mask as a selector, said analytically attention mask being configured to mask the point PTk, k being different from j, of the set of predicted points PT during said step of selecting;
   Generating at least an aligned point PTi′ by processing at least one spatial coordinate of said point PTi according to at least one spatial coordinate of said point PTj, said aligned point PTi′ comprising the same temporal coordinate than said point PTi;
Generating at least said predicted trajectory Y of said agent a at a time t′ where t′∈Tₚᵣₑₚ, where Tₚᵣₑₚ={1, . . . , tₚ} are future time steps, said predicted trajectory Y comprising at least said aligned point PTi′.

The present invention allows to generate temporally consistent trajectories that maintain the cause-effect relationship through time. These consistent trajectories are admissible, meaning that they comply with a map structure, i.e. with the road structure. In the prior art, some solutions that try to achieve the same goal are computationally prohibitive for time-sensitive tasks such as autonomous driving, whereas the present invention has been developed to need less computational power and to be embedded on an autonomous driving system, for example.

According to an embodiment, said invention allows modeling future uncertainty stemming from underlying agents' intentions which are not readily foreseeable.

In the context of the present technology, there is provided methods and electronic devices for predicting a trajectory, preferably of a mobile agent, like an autonomous car for example. Broadly, the present invention uses an innovative temporal alignment technic to generate more accurate and more realistic trajectories.

In some embodiments, said step of aligning is executed N times, N being equal to a number between 1 and the number of points of said set of predicted points PT in order to generate a set of aligned points PT′, said set of aligned points PT′ being configured to define said predicted trajectory Y.

In some embodiments, said analytically attention mask is designed to consider an additional set of points, at least one point of said additional set of points being related to at least one previous trajectory of said agent a.

In some embodiments, said method comprises, before the acquisition step, a step of generating at least said preliminary predicted trajectory Y, said step of generating comprising at least:
Generating at least one goal G from at least one previous trajectory of said agent a using a goal transformer to compute at least one end-point at said time t′;
Predicting a preliminary trajectory comprising at least:
   Selecting at least a starting point, preferably said starting point corresponding to the state s_{A} of the agent a at a time t₀=0;
   Generating at least one intermediate point between said starting point and said predicted end-point;
   Generating at least said set of predicted points PT comprising at least said starting point, at least one intermediate point and at least said end-point;
Generating at least said preliminary predicted trajectory \tilde{Y}, said preliminary predicted trajectory \tilde{Y} comprising at least said set of predicted points PT.

In some embodiments, said step of generating at least one goal comprises at least:
Acquiring at least one previous trajectory;
Generating an intention embedding I by using an embedding based on a discrete set of mode representations, with K vectors of length K, projected to C dimensions by a linear layer Ĩ∈R^{K×C} and added to a learnable parameter Ĩₚ∈R^{K×C}.
Generating at least one goal query comprising a set of inputs, said set of inputs comprising at least:
   Said intention embedding I,
   A local feature hₗ, said local feature hᵢ being generated by processing a predetermined local scene;
   global features h_{g}, said global features h_{g} being generated by processing at least said local feature hₗ with at least information from at least a another local scene;
Computing a goal comprising at least one end-point at time t′ by processing at least said past trajectory with said goal query to generate said end-point at time t′.

In some embodiments, said agent a is part of a multi-agent environment with agents set A (|A|=N) and observed states S_{obs}={s_{α}^{t}:t∈T_{obs}, a∈A} where T_{obs}={−t₀, . . . , 0} are the observation time steps, and wherein the step computing a goal uses a multi-head attention mechanism defined by:

$${A}_{h} ( Q , K , V ) = S ( \frac{1}{\sqrt{d}} {QW}_{h}^{q} {( {KW}_{H}^{k} )}^{T} ) {VW}_{h}^{v}$$

$$M ( Q , K , V ) = {Concat}_{h = 1}^{{N}_{h}} ( {A}_{h} ( Q , K , V ) ) W°$$

where Q, K, and V are query, key and value respectively, Wₕ^{q}, Wₕ^{k} and Wₕ^{v} are their corresponding weights for head h, d is a feature dimension, W^{o} is a weight matrix for a final multi-head output, and S is a Softmax operation.

In some embodiments, the operation of one layer of said goal transformer is given by:

$${h}_{gm} = M L P ( {h}_{g} ‖ {h}_{l} ‖ I )$$

$${Q}^{g} = M ( {Q}^{g} + {P}_{q} , {Q}^{g} + {P}_{q} , {Q}^{g} )$$

$${Q}^{g} = M ( {Q}^{g} + {P}_{q} , {h}_{gm} + {P}_{h} , {H}_{gm} )$$

$${Q}^{g} = M L P ( {Q}^{g} )$$

where P_{q} and Pₕ are positional embedding for the query and the memory feature respectively, and where MLP is a multilayer perceptron.

In some embodiments, the step of aligning uses an operation on at least one single layer according to the following:

$${Y}^{′} = {\tilde{Y}}_{T \times ( 4 \times N ) \times K} + {P}_{t}$$

$$T ( {Y}^{′} , {M}_{t} ) = S ( \frac{1}{\sqrt{d}} {Y}^{′} {W}_{h}^{q} {( {Y}^{′} {w}_{h}^{k} )}^{T} + {M}_{t} ) \tilde{Y} {W}_{h}^{v}$$

where S is the Softmax operation, Pₜ is learnable position embedding, and Mₜ is the attention mask, \tilde{Y} is the preliminary predictions, Ws are the learnable weights.

In some embodiments, the local feature comprise at least one data related to the state of said agent a, said data being taken among at least: one spatial coordinate, a speed, an acceleration, a weight, a spatial dimension.

In some embodiments, at least one among the local feature and the global features comprise at least one data provided by at least said set of sensors.

In some embodiments, the global features comprise at least one data related to said map MAP.

In some embodiments, said map MAP comprises at least one data regarding at least one road.

In some embodiments, said database comprise data regarding at least said agent a and/or said map MAP.

The present invention also relates to an electronic device configured to predict at least one trajectory Y of at least one agent a, said electronic device comprising at least:
One temporal module TM configured to:
   acquire at least one preliminary predicted trajectory \tilde{Y}, said preliminary predicted trajectory comprising a set of predicted points PT, this set of predicted points PT defining said preliminary predicted trajectory \tilde{Y}, each point of said set of predicted points PT comprising at least one spatial coordinate and one temporal coordinate;
   Align at least one point PTi of said set of predicted points PT with at least one point PTj of said set of predicted points PT using an analytically attention mask;
   Generate at least said predicted trajectory Y of said agent a at a time t′ where t′∈Tₚᵣₑₚ, where Tₚᵣₑₚ={1, . . . , tₚ} are future time steps, said predicted trajectory Y comprising at least said aligned point PTi′.

In some embodiments, said electronic device comprises at least one goal module GM configured to generate at least one goal of at least said agent a from at least one previous trajectory of said agent a, preferably using a goal transformer configured to compute at least one end-point at said time t′.

In some embodiments, said electronic device comprises at least one prediction module PM configured to predict a preliminary trajectory \tilde{Y} by at least:
Selecting at least a starting point, preferably said starting point corresponding to the state s_{A} of the agent a at a time t₀=0;
Generating at least one intermediate point between said starting point and said predicted end-point;
Generating at least said set of predicted points PT comprising at least said starting point, at least one intermediate point and at least said end-point.
Generating at least said preliminary predicted trajectory \tilde{Y} comprising at least said starting point, at least said intermediate point and at least said end-point.

According to an embodiment, the present invention relates also to a prediction system comprising at least one electronic device according to the present invention and at least one database and/or one set of sensors.

According to another embodiment, the present invention relates to a computer product program which, when executed by at least one electronic device or prediction system, executes the method according to the present invention.

According to another embodiment, a non-volatile memory comprising at least one computer program product according to the present invention.

In a further broad aspect of the present technology, there is provided a computer-readable medium for storing program instructions for causing an electronic device to perform a method of predicting at least one trajectory Y of at least one agent a. The agent α is in a state s_{A} at a time t, where t∈T_{obs}, where T_{obs}={−t₀, . . . , 0} are observations time step. The agent α is configured to be mobile according to at least one map Map. The method comprises acquiring at least one preliminary predicted trajectory \tilde{Y}, the preliminary predicted trajectory comprising a set of predicted points PT, the set of predicted points PT defining the preliminary predicted trajectory \tilde{Y}, each point of the set of predicted points PT comprising at least one spatial coordinate and one temporal coordinate. The method comprises aligning at least one point PTi of the set of predicted points PT with at least one point PTj of the set of predicted points PT using a mask. The aligning comprises selecting at least the point PTj taken among the set of predicted points PT using the mask, the mask being configured to mask the point PTk, k being different from j, of the set of predicted points PT. The aligning comprises generating at least an aligned point PTi′ by processing at least one spatial coordinate of the point PTi according to at least one spatial coordinate of the point PTj, the aligned point PTi′ comprising the same temporal coordinate than the point PTi. The method comprises generating at least the predicted trajectory Y of the agent α at a time t′ where t′∈Tₚᵣₑₚ, where Tₚᵣₑₚ={1, . . . , tₚ} are future time steps, the predicted trajectory Y comprising at least the aligned point PTi′.

In the context of the present technology, “object detection”, like “line detection” for example, may refer to a computer technology related to computer vision and image processing that deals with detecting instances of semantic objects of a certain class in digital images and/or videos. In the context of the present technology, “computer vision” may refer to a field of artificial intelligence (AI) enabling computers to derive information from images and videos. In the context of the present technology, “natural language processing” may refer an interdisciplinary subfield of linguistics, computer science, and artificial intelligence concerned with the interactions between computers and human language. In the context of the present technology, “supervised learning” may refer to a machine learning paradigm for problems where the available data consists of labelled examples, meaning that each data point contains features and an associated label. In the context of the present technology, “unsupervised learning” may refer to techniques employed by machine learning algorithms to analyze and cluster unlabeled datasets. In the context of the present technology, “self-supervised learning” may refer to a machine learning process where the model trains itself to learn one part of the input from another part of the input. In the context of the present technology, “semi-supervised learning” may refer to a learning problem that involves a small portion of labeled examples and a large number of unlabeled examples from which a model must learn and make predictions on new examples. In the context of the present technology, “image classification” may refer to categorization and labeling of different groups of images.

In the context of the present technology, a “softmax function” may refer to a function that turns a vector of K real values into a vector of K real values that sum to 1.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system.

In the context of the present specification, the expression “set of sensors” is a set of devices or modules configured to collect at least one data, preferably a physical data from the physical world. A sensor can be a camera, a pressure sensor, a temperature sensor, a localization device, etc . . . .

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expressions “component” and “module” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates an example of a prediction method according to an embodiment of the present invention.

FIG. 2 illustrates an attention mask and a step of generating aligned points using said attention mask and according to an embodiment of the present invention.

FIG. 3 illustrates an electronic device according to an embodiment of the present invention.

FIG. 4 illustrates several steps of a method according to the present invention.

FIG. 5 illustrates different modules of the electronic device according to an embodiment of the present invention.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

The present technology, i.e. invention, relates to a method and a system for predicting at least one trajectory of at least one agent, preferably in a multi-agents environment.

Advantageously, the present invention can be implemented as modules on any trajectory prediction algorithm. As mentioned above, a highly valuable application of the present invention is its role in Autonomous Driving Systems.

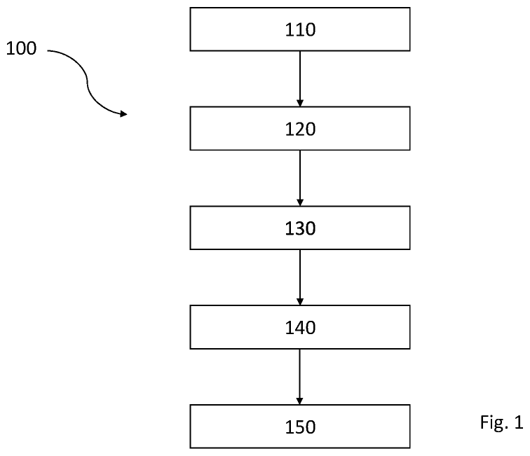

According to an embodiment, and as illustrated by FIGS. 1 to 5, the present invention relates to prediction method 100 of at least one trajectory Y of at least one agent a 10. Preferably said agent a 10 is in a state s_{A} at a time t, where t∈T_{obs}, where T_{obs}={−t₀, . . . , 0} are observations time steps. Said agent a 10 is configured to be mobile according to at least one map MAP 20. Said map MAP 20 can comprise at least one landmark and/or line 21 defining for example a road, and/or lane center, road boundaries, traffic signs, etc . . . . Advantageously, the method 100 according to the present invention is executable by at least one electronic device 200. As described hereafter, said electronic device 200 is communicatively coupled to at least one database 40 and/or at least one set of sensors 50.

According to an embodiment, said map MAP 20 can comprise data regarding roads, streets, and buildings.

According to an embodiment, said database 40 can comprise data regarding the agent a 10 and/or the map MAP 20.

According to an embodiment, the present invention relates to a method 100 of Temporal Transductive Alignment (TTA) for generating a predicted trajectory. Said method 100 is configured to enforce the temporal cause-effect relationship over the time steps, optionally in a non-autoregressive way.

The present invention has been developed considering the fact that real life driving trajectories ought to be smooth over short time horizon resulting from the physical constraints of maneuvering vehicles. This means that the short-term trajectories should follow a consistent path without any apparent oscillating pattern. The proposed method re-aligns the predicted trajectories to ensure a temporal consistency across different time-steps over a short time horizon.

As described hereafter, the temporal module TM 240, also called TTA, can comprise an attention-based operator that uses an analytically attention mask 35 to enforce temporal consistency, preferably within a short-term temporal window t_{w}. In the context of the present invention, a short-term temporal window may refer to a temporal window between 0.1 second and 0.5 second, i.e. between 2 Hz to 10 Hz for example. Indeed, oscillation at these frequencies is physically impossible for a human-driven vehicle. Hence, the present invention addresses these oscillations during the prediction period by using a short-term temporal window that fits into said prediction period.

Advantageously, the present invention uses a masked self-attention and a T×T mask Mₜ 35 over a temporal dimension, producing the final predictions of trajectories.

According to an embodiment, the method 100 comprises:
Acquiring 110 at least one preliminary predicted trajectory \tilde{Y}. According to an embodiment, said preliminary predicted trajectory \tilde{Y} comprises at least a set of predicted points PT 36. Said set of predicted points PT 36 are configured to define said preliminary predicted trajectory \tilde{Y}. Advantageously, each point of said set of predicted points PT 36 comprises at least one spatial coordinate and one temporal coordinate. As described hereafter, said step of acquiring 110 at least one preliminary predicted trajectory \tilde{Y} is configured to be executed by at least one temporal module TM 240 of said electronic device 200.
Autoregressively aligning 120 at least one point PTi of said set of predicted points PT 36 with at least one point PTj of said set of predicted points PT 36. Said point PTj is preferably different from said point PTi. Advantageously, said step of aligning use an analytically attention mask 35. Said analytically attention mask 35 is advantageously configured to enforce temporal consistency within a predetermined temporal window t_{w}. According to an embodiment, said step of aligning 120 is configured to be executed by said temporal module TM 240. According to said embodiment, said step of aligning 120 comprises at least:
   Selecting 130 at least said point PTj taken among the set of predicted points PT 36. Said step of selecting 130 is executed using advantageously said analytically attention mask 35 as a selector. Preferably, said analytically attention mask 35 is configured to mask the point PTk, k being different from j, of the set of predicted points PT 36 during said step of selecting;
   Generating 140 at least one aligned point PTi′ 37. According to an embodiment, said step of generating 140 comprises processing at least one spatial coordinate of said point PTi according to at least one spatial coordinate of said point PTj. Said step of generating 140 uses advantageously at least one function. Preferably, said aligned point PTi′ 37 comprises the same temporal coordinate than said point PTi, and advantageously at least one different spatial coordinate than said point PTi;
Generating 150 at least said predicted trajectory Y of said agent a 10 at a time t′ where t′∈Tₚᵣₑₚ, and where Tₚᵣₑₚ={1, . . . , tₚ} are future time steps. According to an embodiment, said step of generating 150 is configured to be executed by said temporal module TM 240. Advantageously, said predicted trajectory Y comprises at least said aligned point PTi′ 37. According to an embodiment, said step of aligning 120 can be executed multiple times, for example for i=1 to N, N being the number of points of said set of predicted points PT 36 in order to generate a set of aligned points PT′ 37, said set of aligned points PT′ 37 defining said predicted trajectory Y.

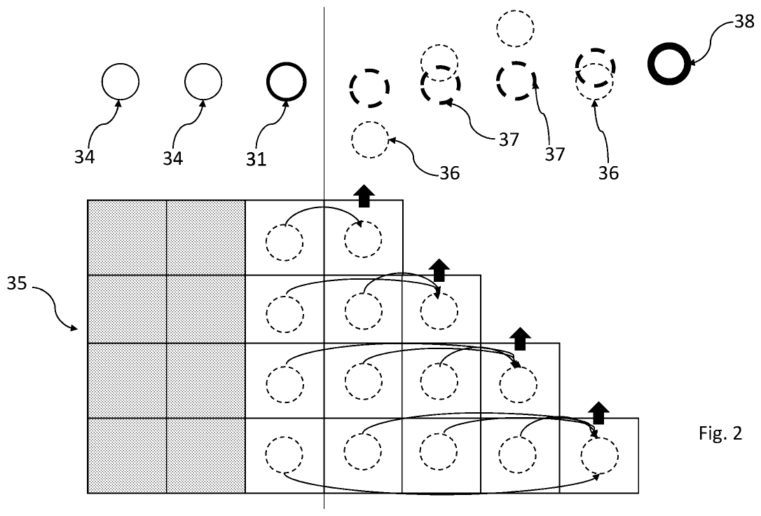

As illustrated by FIG. 2, the analytically attention mask 35 is advantageously designed to act as a selector. Said selector is designed to select points among said set of predicted points PT 36 that will be used to align a predetermined point with at least another point of said set of predicted points PT 36, and preferably with at least one starting point 31 and/or end-point 33. Said attention mask 35 is configured to mask some points, for example to mask past trajectories points. According to an embodiment, said attention mask is configured to select the point PTi among the set of predicted points PT 36.

According to an embodiment, and as illustrated by FIG. 2, an aligned point PTi′ 37 is generated by processing at least one spatial coordinate of said point PTi 36 according to at least one spatial coordinate of several other points PTj 36. Said points PTj 36 are located in the past regarding the selected point PTi. Preferably, said point PTj is located between at least one starting point 31 and said point PTi.

According to an embodiment, the analytically attention mask 35 is designed to consider at least one additional set of points. According to an embodiment, said additional set of points 34 is related to at least one previous trajectory of said agent a 10. Said previous trajectory can be stored in a database 40, for example. According to an embodiment, said analytically mask 35 can have a shape designed to consider set of points ahead in time and/or back in time.

According to an embodiment, before the step 110 of acquiring at least said preliminary predicted trajectory \tilde{Y}, the method 100 can comprise a step of generating at least said preliminary predicted trajectory \tilde{Y}. According to an embodiment, said step of generating comprises at least:
Generating at least one goal G 38, preferably from at least one past trajectory, i.e. at least one previous trajectory, of the agent a 10, advantageously using a goal transformer. Said goal transformer is configured to compute at least one end-point 33 at said time t′ from at least said past trajectory. Preferably, said end-point 33 corresponds to a goal 38, i.e. a point where the agent a 10 should be able to go and/or should want to go at said time t′. Advantageously, said end-point 33 is located on at least said map MAP 20. According to an embodiment, said step of generating is configured to be executed by at least a goal module 220 of said electronic device 200;
Predicting a preliminary trajectory, preferably to reach said goal 38, advantageously to reach said end-point 33 at said time t′; said step of predicting a trajectory comprises at least:
   Selecting at least one starting point 31. Preferably, said starting point 31 corresponds to the state s_{A} of the agent a 10 at a time to =0; Said starting point 31 can correspond optionally to the position of said agent a 10 on the map MAP 20 at said time to.
   Generating at least one intermediate point 32 between said starting point 31 and said predicted end-point 33, optionally a plurality of intermediate points 32; Said intermediate point can be generated using a multi-granular prediction scheme, for example, designed to improve map compliance; According to an embodiment, a multi-granular prediction scheme for improved map compliance is used, in which coarse granular trajectories are initially predicted, followed by fine levels. For example, a lower sampling rate, e.g., 1 Hz, can be used for coarse prediction, resulting in an output trajectory with sparser set of points. These points can be referred to as waypoints (see for example the following publication: “K. Mangalam, Y. An, H. Girase, and J. Malik, “From goals, waypoints & paths to long term human trajectory forecasting,” in ICCV, 2021.”), or intermediate or short term goals (see for example the following publication: “M. Lee, S. S. Sohn, S. Moon, S. Yoon, M. Kapadia, and V. Pavlovic, “MUSE-VAE: Multi-scale VAE for environment-aware long term trajectory prediction,” in CVPR, 2022”); Given that for a specific start point 31 and end point 33 an intermediate point 32 in a short distance is unimodal (see for example the following publication: “H. Zhao, J. Gao, T. Lan, C. Sun, B. Sapp, B. Varadarajan, Y. Shen, Y. Shen, Y. Chai, C. Schmid, et al., “TNT: Target-driven trajectory prediction,” in CoRL, 2020.”), a single coarse trajectory for each goal is predicted. According to an embodiment, the present invention uses a model to predict the intermediate points 32 conditioned on both goal and intention embeddings, and outputs predicted points as well as a new estimate of the goal; This allows the invention to further refine the predicted goal;
   Generating at least said set of predicted points PT 36 comprising at least said starting point 31, at least one intermediate point 32 and at least said end-point 33;

According to an embodiment, said step of predicting is configured to be executed by a prediction module 230 of the electronic device 200;
Generating at least said preliminary predicted trajectory Y, said preliminary predicted trajectory Y comprising at least said set of predicted points 36. According to an embodiment, said step of generating is configured to be executed by at least said prediction module 230 of said electronic device 200.

According to an embodiment, the step of generating said goal 38 can comprise at least:
Acquiring at least one past trajectory of said agent a, optionally from at least one database 40; Said step of acquiring at least one past trajectory is configured to be executed by said goal module GM 220;
Generating an intention embedding I, optionally by using an embedding based on a discrete set of mode representations, with K vectors of length K, projected to C dimensions by a linear layer Ĩ∈R^{K×C} and added to a learnable parameter Ĩₚ∈R^{K×C}. Said step of generating an intention embedding I is configured to be executed by said goal module GM 220; According to an embodiment, said intention embedding I is based on a discrete set of mode representations, where a mode is a concrete instantiation of an intention, to enhance diversity and prevent mode collapse (see for example the following publication: “T. Salzmann, B. Ivanovic, P. Chakravarty, and M. Pavone, “Trajectron++: Multi-agent generative trajectory forecasting with heterogeneous data for control,” in ECCV, 2020.”); According to an embodiment, an intention zₐ, for agent a, is used, with K one-hot vectors of length K; this Z={Zₐ: a∈A} is then projected to C dimensional embedding space by at least one linear layer, added to a learnable positional encoding and finally concatenated with the index of agents to get intention embedding representation for all agents in the scene, I.
Generating at least one goal query comprising a set of inputs, said set of inputs can comprise at least:
   Said intention embedding I,
   A local feature hₗ, said local feature hᵢ being generated by processing a predetermined local scene;
   global features h_{g}, said global features h_{g} being generated by processing at least said local feature hₗ with at least information from at least one another local scene;

Said step of generating at least one goal query is configured to be executed by said goal module GM 220;
Computing a goal 38. According to an embodiment, said step of computing a goal 38 is configured to be executed by at least one goal transformer. Said goal is advantageously configured to comprise at least one end-point 33 at time t′. Preferably, said step of computing a goal 38 comprises processing of at least said past trajectory with said goal query to generate said end-point 33 at time t′. Said end-point 33 represents said goal 38.

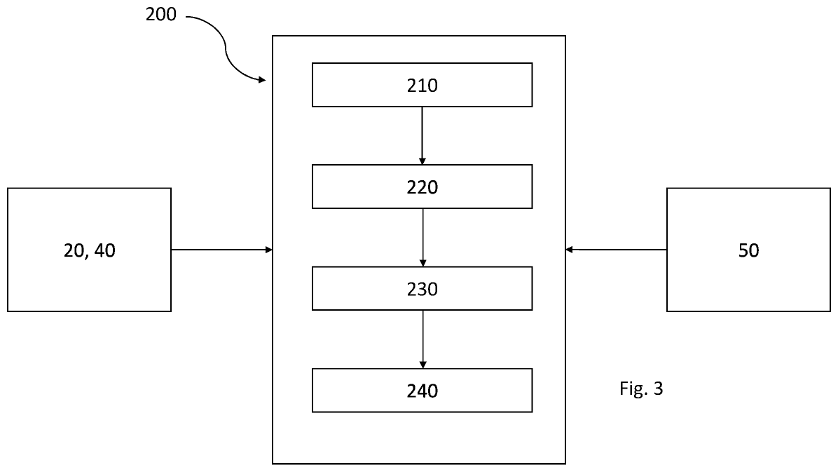

According to an embodiment of the present invention, and as illustrated by FIG. 3, the present invention relates to an electronic device 200. Said electronic device 200 is configured to predict at least one trajectory 30 of at least one agent 10. According to an embodiment, said electronic device 200 comprises at least:
A temporal module TM 240; and
Optionally, an encoder module EM 210; and
Optionally, a goal module GM 220; and
A prediction module PM 230.

According to an embodiment, said temporal module TM 240 is configured to:
acquire at least one preliminary predicted trajectory \tilde{Y}, said preliminary predicted trajectory comprising a set of predicted points PT 36, this set of predicted points PT 36 defining said preliminary predicted trajectory \tilde{Y}, each point of said set of predicted points PT 36 comprising at least one spatial coordinate and one temporal coordinate;
Align at least one point PTi of said set of predicted points PT 36 with at least one point PTj of said set of predicted points PT 36 using an analytically attention mask 35 generating at least one aligned point Pti′ 37.
Generate at least said predicted trajectory Y 30 of said agent a 10 at a time t′ where t′∈Tₚᵣₑₚ, where Tₚᵣₑₚ={1, . . . , tₚ} are future time steps, said predicted trajectory Y 30 comprising at least said aligned point Pti′ 37.

According to an embodiment, the encoder module is configured to produce at least one context representation based on a preprocessing of the dynamics of at least one agent, optionally along with at least one map information. The input of said encoder module can comprise at least past trajectories and/or a map, optionally in the form of a semantic map and/or data from a set of sensors. The output of said encoder module can comprise encoded past trajectories and/or a context representation.

According to an embodiment, and as described further in the following specification, said goal module is configured to generate at least one goal of at least said agent a 10, advantageously to generate at least one goal location at a predetermine time tₚ for at least said agent a 10. The inputs of said goal module can comprise the output of the encoder module. The outputs of said goal module can comprise at least one goal of at least one agent.

According to an embodiment, and as described further in the following specification, said prediction module is configured to generate preliminary predicted trajectories, also called fine-grained trajectories. Said prediction module can use the initial localization of the agent a 10 and its predicted goal, thanks to the goal module, to generate intermediate points and therefore a preliminary predicted trajectory that agent a could follow to reach the generated goal. The inputs of said prediction module can comprise the outputs of the encoder module and/or the output of the goal module. The prediction module is configured to predict and generate future trajectories at different granularity levels, preferably at low sample rate and at a high sample rate. The output of said prediction module can comprise at least one preliminary predicted trajectory, preferably comprising at least one starting point, at least one intermediate point and at least one end-point, i.e. the goal of the agent a 10.

Then, the output of said prediction module are configured to be inputs of the temporal module. Indeed, as previously described, the temporal module is configured to refine the generated trajectories, i.e. the preliminary predicted trajectories, using a masked attention operation as previously described.

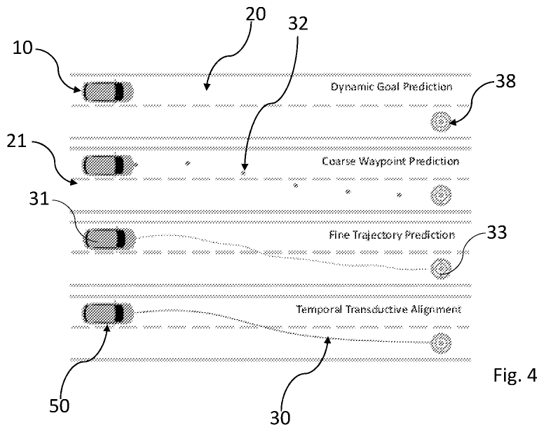

According to an embodiment, and as illustrated by FIG. 4, the present invention uses preliminary predicted trajectory to generate a temporal transductively aligned trajectory. In this figure, an agent 10 is illustrated by a car on a road. Said road comprises some lines 21. These lines are optionally indicated on a map 20. The present invention, according to an embodiment, is configured to take a preliminary predicted trajectory such as the “Fine trajectory prediction” and to generate a predicted trajectory using a temporal transductive alignement method 100. In this figure, a goal 38 or end-point 33 is illustrated. Based on the starting point 31 of the agent 10 and said goal 38, generated as previously described, intermediate points 32 are generated. These intermediate points 32 then are used to generate a preliminary predicted trajectory. Said preliminary predicted trajectory is processed to generate the predicted trajectory of the agent 10 from the starting point 31 to the goal 38.

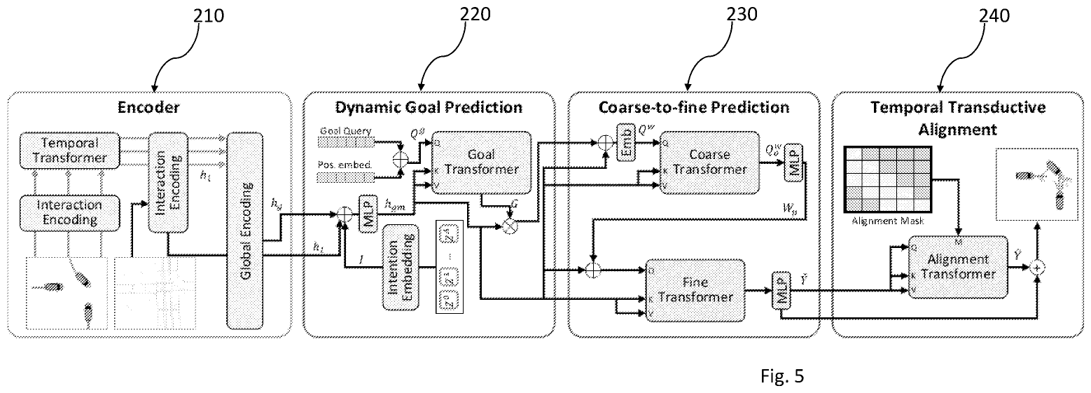

According to an embodiment, and as illustrated in FIG. 5, the present invention relates to a prediction method configured to use a temporal transductive alignment, and optionally a dynamic goal prediction. In the context of the present invention, in order to decode multimodal future trajectories of a predetermined agent and/or of multiple agents, the model can use a goal predictor, i.e. a prediction module 230, advantageously with learned queries, then preferably a transformer based trajectory predictor that predicts trajectory, advantageously at low sampling rate and then at high sampling rate. The present invention uses in a preferred embodiment a temporal transductive alignment process, executed by the temporal module 240, to enforce cause-effect relationship in the temporal dimension in non-autoregressive predictions.

The present invention, according to an embodiment, is context encoding where agents' dynamics along with high-dimensional map information are processed to produce a context representation.

According to an embodiment, dynamic goal prediction module, a transformer-based module, i.e. the goal module GM 220, receives the context encoding as input and learns goal queries to generate potential goal locations at time tₚ for the agents. The outputs of goal prediction and context encoding processes enter coarse-to-fine trajectory prediction, i.e. the prediction module 230, where future trajectories are predicted at two granularity levels: a coarse prediction at a lower sample rate which is used as a query to produce fine-grained trajectories. According to an embodiment, preferably at the end, the temporal transductive alignment process refines the generated trajectories using a masked attention operation, thanks to the temporal module 240.

In the context of the present invention, a continuous space discrete time sample assumption is used (see for example the following publication: “Ming-Fang Chang and John W Lambert and Patsorn Sangkloy and Jagjeet Singh and Slawomir Bak and Andrew Hartnett and De Wang and Peter Carr and Simon Lucey and Deva Ramanan and James Hays, “Argoverse: 3D Tracking and Forecasting with Rich Maps” in CCVPR 2019”), thanks to the sampling rate of the dataset, the data is collected at discrete time steps, for example 0.1 second, and the location of vehicles can be continuous, anywhere on the map. According to an embodiment, the present invention can be applied to a dynamic multi-agent environment with agents set A (|A|=N) and observed states S_{obs}={s_{α}^{t}: t∈T_{obs}, a∈A} where T_{obs}={−t₀, . . . , 0} are the observation time steps. Given a high dimensional map MAP in addition to the observation, thanks to a set of sensors for example, the task is to predict multimodal future trajectories, S_{pred}={s_{α}^{t,k}: t∈T_{pred}, a∈A, k∈K} where T_{pred}={1, . . . , tₚ} are future time steps and K={1, . . . , k} are different modes of predicted trajectories. Each predicted trajectory is associated with a probability score P={p_{α}^{k}: a∈A, k∈K} where Σ_{k∈K} p_{α}^{k}=1. The future states of the agents are its global coordinates given by s_{α}^{t,k}=(x_{α}^{t,k}, y_{α}^{t,k}).

According to an embodiment, and as illustrated by FIG. 5, the present invention can comprise an encoder module EM 210. Said encoder module EM 210 is configured to preprocess agents' dynamics along with high-dimensional map information to produce a context representation. Then, the present invention can comprise the goal module GM 220, a transformer-based module, configured to receive the context encoding as input and to learn goal queries to generate potential goal 38 locations at time tₚ for the agents. The outputs of goal module GM 220 and context encoding module EM 210 enter to the prediction module PM 230, i.e. a coarse-to-fine trajectory prediction where future trajectories are predicted at two granularity levels: a coarse prediction at a lower sample rate which is used as a query to produce fine-grained trajectories. At the end, the temporal module TM 240 is configured to refine the generated trajectories, i.e. the preliminary predicted trajectories, using a masked attention operation as previously described.

According to an embodiment, the present invention represents the attributes of the agents and the scene by converting points into vectors and computing the relative positions, as such an agent's history at a given time step becomes \vec{s}_{α}^{t}=s_{α}^{t}−s_{α}^{t-1}, which has the added advantage of being translation invariant. Advantageously, the interactions between agents, and between agents and the environment are modelled at two different levels, as previously described: At the local level and at a global level. According to an embodiment, at a local level, patches of radius r centered at each agents are extracted, said radius r can be equal to 50 m for example. At each time step, the patches are processes using a self-attention layer to capture spatial relationships. According to an embodiment, the output of these patches are aggregated and fed into a temporal transformer, i.e. the temporal module, to model the temporal relations the output of which, in addition to lane information, are fed into an additional attention layer that captures the local lanes and agents relationships. This process produces a local agent a representation h_{a,l}. At the global level, a message passing operation in conjunction with applying a spatial attention is used to model the interaction between local representations. This produces a global agent representation h_{a,g}.

In the context of the present invention, the objective of goal prediction, i.e. of the goal module GM 220, is to model the underlying intentions of agents as their goals 38, and consequently to enhance the accuracy of predicted trajectories. If estimated accurately, goals 38 can help improve the compatibility of predictions to the map MAP, i.e. to the road structure, i.e. result in admissible predictions that do not extend beyond the road boundaries, for example.

According to an embodiment, the present invention uses an intention representation. According to an embodiment, the present invention uses an embedding based on a discrete set of mode representations, with K one-hot vectors of length K, projected to C dimensions by a linear layer Ĩ∈R^{K×C} and added to a learnable parameter Ĩₚ∈R^{K×C} to get the final embedding Iₑ.

Advantageously, in a context of multi-agents, the intention embedding is then concatenated with the index of agents to get per agent intention embedding representation I_{α}, where I={I_{α}: a∈A}. Together, discrete intention embedding I, local feature hₗ={h_{α,l}: α∈A}, and global features h_{g}={h_{α,g}: α∈A} form the input to a transformer, i.e. a goal transformer.

According to an embodiment, said local feature hₗ comprises at least one data related to the state of said agent a 10, said data being taken among at least: one spatial coordinate, a speed, an acceleration, a weight, a spatial dimension, a nature of a vehicle, . . . .

According to an embodiment, said local feature hₗ can comprise at least one data provided by at least one said set of sensors 50.

According to an embodiment, the global features h_{g} can comprise at least one data related to said map MAP 20 and/or to an environment of said agent a, and/or to said set of sensors 50.

According to an embodiment, the goal module GM 220 has been designed using concepts such as object queries used in other domains of computer vision, for example. Therefore, the present invention takes a different approach than the prior arts that treat the goal setting problem as regression and offset setting, choosing and refining one landmark on the map from the set of possible options, or as a segmentation problem, segmenting the rasterized map to identify the possible future goals.

Advantageously, the output of the goal module GM 220 can be represented as G=F^{s}(W^{s}, h) where F^{s} is the function modeled by the goal predictor, W^{s} corresponds to a model parameters, and h is the embedding from the encoder module EM 210. The parameter W^{s} is optimized during training from the entire training set and captures a generalization over the entire set. This output is therefore configured to provide at least one end-point 33, i.e. one goal 38 to one agent 10.

According to an embodiment, in the proposed dynamic query-based goal predictor, i.e. prediction module PM 230, the operations are Q^{g}=F^{d}(W^{d}, h) and G=F^{q}(Q^{g}, h). Here, Q^{g}, F^{d}, W^{d}, h correspond to goal queries, goal transformer function, goal decoder parameters and the input features, respectively. Advantageously, F^{q} is analogous to the operation of a linear layer in the multi-layer perceptron model which is a matrix multiplication. According to the present invention, the goal transformer parameter W^{d} is optimized during training to generate suitable goal queries Q^{g} for every input. In this context, one can use the term “dynamic” because the goal queries, i.e. the end-points 33, are generated at the inference time by the goal transformer, i.e. the goal module GM 220. Using this formulation makes the goal predictor more adaptive to a given scene as the transformer learns how to focus on predefined features generated by the network at the inference time.

According to said embodiment, the query input to the goal transformer is combined with a learned positional embedding forming an input of shape N×(K×B)×C where N is the number of agents, K is the number of modes, B is 5 corresponding to [x, y, σₓ, σ_{y}, p] that are 2D coordinates of the goals, preferably on a bidimensional map MAP 20, their corresponding scales and the mixture probability of the given mode. The input to the key and value of goal transformer is the combination of the context encoding, namely local hₗ, global h_{g} features, and intentions embedding I, as previously discussed.

The goal transformer uses multi-head attention mechanism defined by:

$${A}_{h} ( Q , K , V ) = S ( \frac{1}{\sqrt{d}} {QW}_{h}^{q} {( {KW}_{H}^{k} )}^{T} ) {VW}_{h}^{v} \qquad ( 1 )$$

$$M ( Q , K , V ) = {Concat}_{h = 1}^{{N}_{h}} ( {A}_{h} ( Q , K , V ) ) W° \qquad ( 2 )$$

where Q, K, and V are query, key and value respectively, Wₕ^{q}, Wₕ^{k} and Wₕ^{v} are their corresponding weights for head h, d is the feature dimension, W^{o} is the weight matrix for the final multi-head output, and S is the Softmax operation.

According to an embodiment, the operation of one layer of the goal transformer is given by,

$${h}_{gm} = M L P ( {h}_{g} ‖ {h}_{l} ‖ I ) \qquad ( 3 )$$

$${Q}^{g} = M ( {Q}^{g} + {P}_{q} , {Q}^{g} + {P}_{q} , {Q}^{g} ) \qquad ( 4 )$$

$${Q}^{g} = M ( {Q}^{g} + {P}_{q} , {h}_{gm} + {P}_{h} , {H}_{gm} ) \qquad ( 5 )$$

$${Q}^{g} = M L P ( {Q}^{g} ) \qquad ( 6 )$$

where P_{q} and Pₕ are positional embedding for the query and the memory feature respectively.

According to an embodiment, goal queries are initially set randomly at the beginning of each iteration and are updated by the goal module to predict the goals. Learned queries Qₖ^{g}εR^{N×B×C} of each mode k∈K are then multiplied with the input feature h_{gm} to get the goal mean position, scale of the distribution, and probability. At the end, all mode probabilities are concatenated and a Softmax is applied to them along the mode dimension.

According to said embodiment, the present invention allows to learn the intentions of at least one agent 10 dynamically. That allows the invention to process trajectories in real time, and preferably to not be map dependent.

According to an embodiment, the present invention uses a multi-granular prediction scheme in which it predicts trajectories at both coarse and fine levels, thanks to the prediction module. As the name implies, for coarse prediction, a lower sampling rate is used resulting in an output trajectory with sparser set of points. These points are often referred to as waypoints, or intermediate goal or short-term goals. Given that for a specific start and end point an intermediate point in a short distance is unimodal, the prediction module is configured to predict a single trajectory for each goal. Contrary to the prior art, the present invention predicts the intermediate points 32 conditioned on both goal 38 and intention embeddings, and outputs preliminary predicted points 36 as well as the goal 38. This allows the module to further refine the predicted goal 38. The predicted goal 38, G, and the features from the encoder and intentions, h_{gm}, are concatenated and passed through an embedding layer serving as the queries for the coarse trajectory module. The inputs to the key and value are the same as query without the goals, i.e. h_{gm}. According to an embodiment, and following the previous equations, the inputs are processed using two attention layers M(Qᵢ^{w}+P_{q}, Qᵢ^{w}+P_{q}, Qᵢ^{w}) and M(Qᵢ^{w}+P_{q}, F^{w}+Pₕ, F^{w}), and an MLP layer to generate waypoints Qₒ^{w} (see for example the following publication: “Haykin, Simon, “Neural networks: a comprehensive foundation”, Prentice Hall PTR, 1994”). A two-layer MLP is used advantageously to generate the final output Wₚ∈R^{K×T}^{_{wp}}^{×4} where T_{wp} is the number of waypoints and 4 the size of each output corresponding to position and scales of the waypoints, according to an embodiment.

According to an embodiment, the fine trajectory prediction module, also called the prediction module 230, produces trajectories at a higher framerate for refinement to produce the final results. According to an embodiment, the architecture of the fine predictor is similar to the coarse one with the main difference of receiving coarse predictor output, instead of predicted goals directly from goal module 220, as the query. Fine predictor generates trajectories \tilde{Y}={\tilde{y}_{α}^{t,k}:t∈1, . . . , T_{pred}; k∈1, . . . ,K; α∈A} where \tilde{y}_{α}^{t,k}=(μₓ_{_{α}}^{t,k}, μ_{y}_{_{α}}^{t,k}, σₓ_{_{α}}^{t,k}, σ_{y}_{_{α}}^{t,k}) with μ and a corresponding to the mean and scale of the output distribution. As a result, \tilde{Y} is of shape N×K×T_{pred}×4.

According to a preferred embodiment, the present invention uses a Temporal Transductive Alignment (TTA) model, executed by said temporal module TM 240, that enforces the temporal cause-effect relationship over the time steps in non-autoregressive manner which conventionally been achieved in autoregressive prediction in the prior art.

As previously indicating, the present invention uses an analytically attention mask to enforce temporal consistency within the short-term temporal window t_{w}, said temporal window being predetermined. Through the development of the present invention, a windowed square-subsequent mask has been identified as being the most effective in this context. The operation for a single layer of TTA can be summarized by,

$${Y}^{′} = {\tilde{Y}}_{T \times ( 4 \times N ) \times K} + {P}_{t} \qquad ( 7 )$$

$$T ( {Y}^{′} , {M}_{t} ) = S ( \frac{1}{\sqrt{d}} {Y}^{′} {W}_{h}^{q} {( {Y}^{′} {w}_{h}^{k} )}^{T} + {M}_{t} ) \tilde{Y} {W}_{h}^{v} \qquad ( 8 )$$

where S is the Softmax operation, Pₜ is learnable position embedding, and Mₜ is the attention mask 35.

The present invention allows to enforce the temporal cause-effect relationship over the time steps in non-autoregressive manner which conventionally been achieved in autoregressive prediction.

According to an embodiment, said electronic device 200 is configured to execute at least a plurality of instructions, preferably stored in a non-volatile storage device; these instructions are configured to execute the method 100 according to the present invention when they are executed by at least one processor of said electronic device 200.

According to an embodiment, said electronic device 200 can comprise or be a computer. Optionally, said electronic device 200 can be coupled with a communication network, for example by way of two-way communication lines. Said electronic device 200 can comprise a user interface, for example a keyboard, a mouse, voice recognition capabilities or other interface permitting the user to access to the electronic device 200. Said electronic device 200 can comprise at least one monitor. Said electronic device 200 can comprise a CPU. Said electronic device 200 can be a a web server.

According to an embodiment, the present invention relates to a prediction system comprising said electronic device 200 and at least one database 40 and/or one set of sensors 50.

According to an embodiment, said set of sensors 50 can be carried at least partially by the agent a 10, for example by a car, advantageously by an autonomous car. Said set of sensors 50 can comprise for example at least one camera, on proximity sensor, one localization sensor, etc . . . .

According to an embodiment, at least one sensor of said set of sensors 50 can be configured to use object detection technics to collect information regarding the environment of said agent a 10. Advantageously, at least one sensor of said set of sensor 50 can be configured to use natural language processing technics to collect information regarding the environment of said agent a 10.

Unless otherwise specified herein, or unless the context clearly dictates otherwise the term about modifying a numerical quantity means plus or minus ten percent. Unless otherwise specified, or unless the context dictates otherwise, between two numerical values is to be read as between and including the two numerical values.

In the present description, some specific details are included to provide an understanding of various disclosed implementations. The skilled person in the relevant art, however, will recognize that implementations may be practiced without one or more of these specific details, parts of a method, components, materials, etc. In some instances, well-known methods associated with artificial intelligence, machine learning and/or neural networks, have not been shown or described in detail to avoid unnecessarily obscuring descriptions of the disclosed implementations.

In the present description and appended claims “a”, “an”, “one”, or “another” applied to “embodiment”, “example”, or “implementation” is used in the sense that a particular referent feature, structure, or characteristic described in connection with the embodiment, example, or implementation is included in at least one embodiment, example, or implementation. Thus, phrases like “in one embodiment”, “in an embodiment”, or “another embodiment” are not necessarily all referring to the same embodiment. Furthermore, the particular features, structures, or characteristics may be combined in any suitable manner in one or more embodiments, examples, or implementations.

As used in this description and the appended claims, the singular forms of articles, such as “a”, “an”, and “the”, can include plural referents unless the context mandates otherwise. Unless the context requires otherwise, throughout this description and appended claims, the word “comprise” and variations thereof, such as, “comprises” and “comprising” are to be interpreted in an open, inclusive sense, that is, as “including, but not limited to”.

All publications referred to in this description, are incorporated by reference in their entireties for all purposes herein.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

### NUMERICAL REFERENCES

10 Agent a
20 Map
21 Line of a road
30 Trajectory
31 Starting point
32 Intermediate point
33 End-point
34 Points of a past trajectory
35 Attention mask
36 Point of a preliminary predicted trajectory
37 temporally aligned point
38 Goal
40 Database
50 Set of sensors
100 Prediction method
110 Step of acquiring at least one preliminary predicted trajectory
120 Step of aligning at least one point
130 Step of selecting a point
140 Step of generating an aligned point
150 Step of generating at least one predicted trajectory
200 Electronic device
210 Encoder module
220 Goal module
230 Prediction module
240 Temporal module

1. A method of predicting at least one trajectory Y of at least one agent a, the agent a being in a state s_{A} at a time t, where t∈T_{obs}, where T_{obs}={−t₀, . . . , 0} are observations time steps, the agent a being configured to be mobile according to at least one map Map, the method being executable by an electronic device, the electronic device being communicatively coupled to at least one database and/or at least one set of sensors, the method comprising:
acquiring at least one preliminary predicted trajectory Y, the preliminary predicted trajectory comprising a set of predicted points PT, the set of predicted points PT defining the preliminary predicted trajectory Y, each point of the set of predicted points PT comprising at least one spatial coordinate and one temporal coordinate;
aligning at least one point PTi of the set of predicted points PT with at least one point PTj of the set of predicted points PT using a mask, the aligning comprising:
selecting at least the point PTj taken among the set of predicted points PT using the mask, the mask being configured to mask the point PTk, k being different from j, of the set of predicted points PT; and
generating at least an aligned point PTi′ by processing at least one spatial coordinate of the point PTi according to at least one spatial coordinate of the point PTj, the aligned point PTi′ comprising the same temporal coordinate than the point PTi; and
generating at least the predicted trajectory Y of the agent α at a time t′ where t′∈Tₚᵣₑₚ, where Tₚᵣₑₚ={1, . . . , tₚ} are future time steps, the predicted trajectory Y comprising at least the aligned point PTi′.

2. The method of claim 1, wherein the aligning is executed N times, N being equal to a number between 1 and the number of points of the set of predicted points PT in order to generate a set of aligned points PT′, the set of aligned points PT′ defining the predicted trajectory Y.

3. The method of claim 1, wherein the mask is configured to consider an additional set of points, at least one point of the additional set of points being associated with at least one previous trajectory of the agent a.

4. The method of claim 1, further comprising, before the acquiring, generating at least the preliminary predicted trajectory Y, the generating comprising at least:
generating at least one goal G from at least one previous trajectory of the agent a using a goal transformer to compute at least one end-point at the time t′;
predicting a preliminary trajectory comprising at least:
selecting at least a starting point, the starting point corresponding to the state s_{A} of the agent a at a time t₀=0;
generating at least one intermediate point between the starting point and the predicted end-point; and
generating at least the set of predicted points PT comprising at least the starting point, at least one intermediate point and at least the end-point; and
generating at least the preliminary predicted trajectory \tilde{Y}, the preliminary predicted trajectory \tilde{Y} comprising at least the set of predicted points PT.

5. The method of claim 1, wherein the generating at least one goal comprises at least:
acquiring at least one previous trajectory;
generating an intention embedding I by using an embedding based on a discrete set of mode representations, with K vectors of length K, projected to C dimensions by a linear layer Ĩ∈R^{K×C} and added to a learnable parameter Ĩₚ∈R^{K×C};
generating at least one goal query comprising a set of inputs, the set of inputs comprising at least:
the intention embedding I,
a local feature hₗ, the local feature hₗ being generated by processing a predetermined local scene;
global features h_{g}, the global features h_{g} being generated by processing at least the local feature hₗ with at least information from at least a another local scene; and
computing a goal comprising at least one end-point at time t′ by processing at least the past trajectory with the goal query to generate the end-point at time t′.

6. The method of claim 1, wherein the agent a is part of a multi-agent environment with agents set A (|A|=N) and observed states S_{obs}={s_{α}^{t}: t∈T_{obs}, a∈A} where T_{obs}={−t₀, . . . , 0} are the observation time steps, and wherein the computing a goal is executed using a multi-head attention mechanism defined by:
$${A}_{h} ( Q , K , V ) = S ( \frac{1}{\sqrt{d}} {QW}_{h}^{q} {( {KW}_{H}^{k} )}^{T} ) {VW}_{h}^{v}$$
$$M ( Q , K , V ) = {Concat}_{h = 1}^{{N}_{h}} ( {A}_{h} ( Q , K , V ) ) W°$$
where Q, K, and V are query, key and value respectively, Wₕ^{q}, Wₕ^{k} and Wₕ^{v} are their corresponding weights for head h, d is a feature dimension, W^{o} is a weight matrix for a final multi-head output, and S is a Softmax operation.

7. The method of claim 1, wherein the operation of one layer of the goal transformer is given by:
$${h}_{gm} = M L P ( {h}_{g} ‖ {h}_{l} ‖ I )$$
$${Q}^{g} = M ( {Q}^{g} + {P}_{q} , {Q}^{g} + {P}_{q} , {Q}^{g} )$$
$${Q}^{g} = M ( {Q}^{g} + {P}_{q} , {h}_{gm} + {P}_{h} , {H}_{gm} )$$
$${Q}^{g} = M L P ( {Q}^{g} )$$
where P_{q} and Pₕ are positional embedding for the query and the memory feature respectively, and where MLP is a multilayer perceptron.

8. The method of claim 1, wherein the aligning is executed using an operation on at least one single layer according to the following:
$${Y}^{′} = {\tilde{Y}}_{T \times ( 4 \times N ) \times K} + {P}_{t}$$
$$T ( {Y}^{′} , {M}_{t} ) = S ( \frac{1}{\sqrt{d}} {Y}^{′} {W}_{h}^{q} {( {Y}^{′} {w}_{h}^{k} )}^{T} + {M}_{t} ) \tilde{Y} {W}_{h}^{v}$$
where S is the Softmax operation, Pₜ is learnable position embedding, and Mₜ is the mask, \tilde{Y} is the preliminary predictions, Ws are the learnable weights.

9. The method of claim 5, wherein the local feature comprises information related to the state of the agent a, the information being taken among at least: one spatial coordinate, a speed, an acceleration, a weight, a spatial dimension.

10. The method of claim 5, wherein at least one among the local feature and the global features comprises information provided by at least the set of sensors.

11. The method of claim 5, wherein the global features comprise information related to the map Map.

12. The method of claim 1, wherein the map Map comprises information regarding at least one road.

13. The method of claim 1, wherein the database comprises information regarding at least the agent a and/or the map Map.

14. An electronic device configured to predict at least one trajectory Y of at least one agent a, the electronic device being configured to:
acquire at least one preliminary predicted trajectory Y, the preliminary predicted trajectory comprising a set of predicted points PT, the set of predicted points PT defining the preliminary predicted trajectory Y, each point of the set of predicted points PT comprising at least one spatial coordinate and one temporal coordinate;
align at least one point PTi of the set of predicted points PT with at least one point PTj of the set of predicted points PT using a mask; and
generate at least the predicted trajectory Y of the agent a at a time t′ where t′∈Tₚᵣₑₚ, where Tₚᵣₑₚ={1, . . . , tₚ} are future time steps, the predicted trajectory Y comprising at least the aligned point PTi′.

15. The electronic device of claim 14, wherein the electronic device is further configured to generate at least one goal of at least the agent a from at least one previous trajectory of the agent a, using a goal transformer configured to compute at least one end-point at the time t′.

16. The electronic device of claim 15, where the electronic device is further configured to predict a preliminary trajectory Y by at least:
selecting at least a starting point, the starting point corresponding to the state s_{A} of the agent a at a time t₀=0;
generating at least one intermediate point between the starting point and the predicted end-point;
generating at least the set of predicted points PT comprising at least the starting point, at least one intermediate point and at least the end-point; and
generating at least the preliminary predicted trajectory Y comprising at least the starting point, at least the intermediate point and at least the end-point.

17. A computer-readable medium for storing program instructions for causing an electronic device to perform a method of predicting at least one trajectory Y of at least one agent a, the agent α being in a state s_{A} at a time t, where t∈T_{obs}, where T_{obs}={−t₀, . . . , 0} are observations time steps, the agent a being configured to be mobile according to at least one map Map, the method comprising:
acquiring at least one preliminary predicted trajectory Y, the preliminary predicted trajectory comprising a set of predicted points PT, the set of predicted points PT defining the preliminary predicted trajectory Y, each point of the set of predicted points PT comprising at least one spatial coordinate and one temporal coordinate;
aligning at least one point PTi of the set of predicted points PT with at least one point PTj of the set of predicted points PT using a mask, the aligning comprising:
selecting at least the point PTj taken among the set of predicted points PT using the mask, the mask being configured to mask the point PTk, k being different from j, of the set of predicted points PT; and
generating at least an aligned point PTi′ by processing at least one spatial coordinate of the point PTi according to at least one spatial coordinate of the point PTj, the aligned point PTi′ comprising the same temporal coordinate than the point PTi; and
generating at least the predicted trajectory Y of the agent α at a time t′ where t′∈Tₚᵣₑₚ, where Tₚᵣₑₚ={1, . . . , tₚ} are future time steps, the predicted trajectory Y comprising at least the aligned point PTi′.
